(19) United States
(12) Patent Application Publication
(10) Pub. No.: US 2024/0199956 A1
(43) Pub. Date: Jun. 20, 2024

(54) COAL GANGUE-BASED ECOLOGICAL RESTORATION MATERIAL, AND PREPARATION METHOD AND APPLICATION THEREOF

(71) Applicant: Taiyuan University of Science and Technology Ltd., Taiyuan (CN)

(72) Inventors: Shaoqing Guo, Taiyuan (CN); Fan Gao, Taiyuan (CN); Xianxian Wei, Taiyuan (CN); Libing Gao, Taiyuan (CN); Yanzhi Cao, Taiyuan (CN); Bingzheng Li, Taiyuan (CN)

(21) Appl. No.: 18/540,900

(22) Filed: Dec. 15, 2023

(30) Foreign Application Priority Data
Dec. 16, 2022 (CN) 2022116189450

(51) Int. Cl. C09K 17/50; C05F 7/00; C05F 11/02; C09K 101/00; C09K 105/00

(52) U.S. Cl. CPC C09K 17/50; C05F 7/005; C05F 11/02; C09K 2101/00; C09K 2105/00

(57) ABSTRACT

A coal gangue-based ecological restoration material, and a preparation method and an application thereof are provided. The coal gangue-based ecological restoration material is made from the following raw materials in parts by weight: 10 parts by weight of coal gangue; 0.5-1 parts by weight of an adhesive; 1-10 parts by weight of a plant fiber; and 1 part by weight of a fertilizer. The preparation method of the coal gangue-based ecological restoration material includes: primary crushing, primary heat treatment, primary cooling, secondary crushing, mixing and molding, secondary heat treatment, secondary cooling, mixing, and cooling and molding. The method uses the coal gangue as a main raw material to prepare the ecological restoration material, which can realize the effective utilization of the coal gangue and has good environmental protection, economic and social benefits.

### TECHNICAL FIELD

The disclosure relates to the field of comprehensive utilization technologies of coal gangue, and more particularly to a preparation method of a coal gangue-based ecological restoration material and an application of a coal gangue-based ecological restoration material.

### BACKGROUND

Coal gangue is a typical solid waste generated during a coal mining process, generally with low carbon content and high ash content. Although there are some disposal methods being used, such as incineration for power generation, production of building materials or ceramics, and extraction of valuable metals, there is no low-cost, large-scale disposal technology for coal gangue. Therefore, the low-cost and large-scale disposal technology and application have become a bottleneck problem in the solid waste treatment of coal gangue.

Currently, ecological restoration typically involves the comprehensive management of ecological environmental issues using engineering, biological, and other technical methods. During the management process, some ecological restoration materials are used. Among them, artificial carbon-containing composite materials, such as biochar-nanocomposites and modified biochar materials, are commonly used ecological restoration materials, which can achieve good ecological restoration effects. However, the high cost of the above materials limits their large-scale use in ecological management, so it is necessary to develop an inexpensive ecological restoration material. Coal gangue contains both inorganic and organic substances, so theoretically, processing coal gangue into a carbon-containing composite material is feasible. If the coal gangue is further processed into ecological restoration materials, it will be an effective way to comprehensively utilize the coal gangue. Currently, there are also some methods for processing the coal gangue into materials that can be used for ecological management. For example, Chinese patent with application No. CN 202010502984 (corresponding to publication No. CN111699941A) discloses a coal gangue greening substrate, a preparation method and an application thereof, the coal gangue greening substrate is prepared by mixing coal gangue, soil, plant pulverized matter, coal ash, and water-retaining agent uniformly. However, in this method, the coal gangue is only used as an ingredient, and the coal gangue has not been activated by heat treatment, so it can only be used as a greening substrate, but not as a general ecological restoration material. Chinese patent with application No. CN201910346507 (corresponding to publication No. CN110016349A) discloses a method for preparing a heavy metal soil restoration material by using coal gangue, the method includes: processing 20 parts by weight of the coal gangue, 15-20 parts by weight of limestone or phosphogypsum, and 1-2 parts by weight of an auxiliary agent to obtain the heavy metal soil restoration material; this method effectively utilizes the waste coal gangue, limestone or phosphogypsum resources, and can realize the recycling of various wastes such as coal gangue, limestone or phosphogypsum; but it only prepares the heavy metal soil restoration material for restoration of heavy metal contaminated soil, rather than universal ecological restoration materials. Processing coal gangue into ecological restoration materials will hopefully realize comprehensive utilization of coal gangue and low-cost restoration of ecological environment, and achieve good economic, social and environmental benefits.

### SUMMARY

The disclosure aims to provide a preparation method of an ecological restoration material by using coal gangue, the coal gangue is used as a main raw material of the ecological restoration material, so as to realize large-scale utilization of coal gangue, and has multiple benefits of environmental protection, economy and the like.

The disclosure takes the coal gangue as a raw material, and the coal gangue includes a certain amount of organic components and a certain amount of inorganic components such as silicon dioxide. During the low-temperature anoxic heat treatment of the coal gangue, the organic and inorganic components in the coal gangue are pyrolyzed, and some volatile components in the coal gangue and some heavy metal pollution elements such as sulfur (S), nitrogen (N) and mercury (Hg) are released. At the same time, the organic and inorganic components are fused with each other in the pyrolysis process, and after cooling, they are crushed to less than 250 meshes to form a composite of organic and inorganic materials with uniform texture, then the composite of organic and inorganic materials is molded, and activated by high-temperature carbon dioxide under a certain pressure, so that carbon dioxide reacts with the organic and inorganic components in the composite to make the composite become a loose carbon-containing composite. Then, the loose carbon-containing composite is stirred and mixed with a plant fiber and a fertilizer at a certain temperature and undergoes a decay reaction, which accelerates the decay ability of the plant fiber under the action of the fertilizer, and finally increases the humus content in the carbon-containing composite, so that the final product becomes a good ecological restoration material.

The disclosure provides a coal gangue-based ecological restoration material, made from the following raw materials in parts by weight:
10 parts by weight of coal gangue;
0.1-1 parts by weight of an adhesive;
1-10 parts by weight of a plant fiber; and
1 part by weight of a fertilizer.

The disclosure provides a preparation method of the above ecological restoration material by using the coal gangue, in the method, the coal gangue is transformed into the ecological restoration material through the processes of primary crushing, primary heat treatment, primary cooling, secondary crushing, mixing and molding, secondary heat treatment, secondary cooling, mixing, and cooling and molding.

In the above method, the method specifically includes the following steps:
(1) primary crushing: crushing the coal gangue by a crusher to obtain first powder less than 80 meshes;
(2) primary heat treatment: placing the first powder in a heating furnace to perform heat treatment at 300-500° C. without air or in inert atmosphere for 30-60 minutes to obtain heat-treated powder;
(3) primary cooling: cooling the heat-treated powder to below 50° C. by indirect cooling (without direct contact with cooling water) to obtain cooled powder;
(4) secondary crushing: crushing and sieving the cooled powder to below 250 meshes to obtain second powder less than 250 meshes;
(5) mixed and molding: putting the second powder and the adhesive into a stirring molding device to stir and mix, and mold into spherical particles with a particle size of 6-10 mm;
(6) secondary heat treatment: placing the molded spherical particles in a heating furnace, introducing carbon dioxide gas into the heating furnace at 750° C. and 0.5-1 MPa, and performing heat treatment on the spherical particles in the heating furnace for 30-60 minutes to obtain a heat-treated material;
(7) secondary cooling: directly spraying alkaline aqueous solution on the heat-treated material to cool it to 70-80° ° C. to obtain a cooled material;
(8) mixing: evenly stirring and mixing the cooled material, the plant fiber and the fertilizer at 70-80° ° C. for 30-120 minutes according to a weight ratio of 10:(1-10):1, to obtain a mixed material; and
(9) cooling and molding: cooling the mixed material to obtain the coal gangue-based ecological restoration material.

In the above method, the coal gangue is coal gangue with silicon oxide content higher than 60% and carbon content higher than 20%.

In the above method, the adhesive is a mixture of asphalt and carboxymethyl cellulose in a weight ratio of 1:1 to 1:5.

In the above method, the plant fiber is one selected from the group consisting of a cotton straw fiber, a rice straw fiber and a corn straw fiber.

In the above method, the fertilizer is an organic fertilizer or a chemical fertilizer or a mixture of an organic fertilizer and a chemical fertilizer; and the organic fertilizer is animal manure, and the chemical fertilizer is urea.

In the above method, the alkaline aqueous solution includes: 1% sodium hydroxide aqueous solution, 1% potassium hydroxide aqueous solution or 10%-15% sodium carbonate aqueous solution; and a weight ratio of the alkaline aqueous solution to the heat-treated material is 1 to 3:10.

In the above method, the finished coal gangue-based ecological restoration material refers to a material with loose texture and rich oxygen required by humus and other plants, so that it can replace the surface soil for ecological restoration.

In the disclosure, the ecological restoration material prepared by the method can be used as the ecological restoration material for water and soil loss areas with desertification and rocky desertification, and lands occupied by construction.

Furthermore, when the coal gangue-based ecological restoration material is used as the ecological restoration material in the water and soil loss area with desertification and rocky desertification, the coal gangue-based ecological restoration material is directly laid on the surface of the water and soil loss area with desertification and rocky desertification, with a laying thickness of 50-100 mm, and then local plant grass seeds are directly sprayed on it. After three months of construction, the vegetation coverage rate is more than 80%.

Furthermore, when the coal gangue-based ecological restoration material is used in an area needing ecological restoration in the land occupied by construction, the coal gangue-based ecological restoration material is directly laid on the ground surface of the land occupied by construction, with a laying thickness of 50-100 mm, and then local plant grass seeds are directly sprayed on it. After three months of construction, the vegetation coverage rate is more than 80%.

The disclosure has beneficial effects as follows.
(1) Using the coal gangue to prepare the ecological restoration material can realize the effective utilization of the coal gangue.
(2) The material is cheap and easy to obtain, which effectively reduces the restoration cost of the ecological environment and has remarkable economic benefits for environmental protection.

### DETAILED DESCRIPTION OF EMBODIMENTS

The disclosure will be further illustrated by the following embodiments, but not limited to the following embodiments.

### Embodiment 1

Coal gangue with a weight content of silicon oxide (SiO₂) higher than 60% and a weight content of carbon (C) higher than 20% as a raw material is crushed by a crusher to obtain first powder less than 80 meshes. The first powder is placed in a heating furnace for heat treatment at 300° C. without air for 60 minutes to obtain heat-treated powder. The heat-treated powder is cooled to below 50° C. by indirect cooling to obtain cooled powder. The cooled powder is crushed and sieved to less than 250 meshes to obtain second powder less than 250 meshes. The second powder is put into a stirring molding device with an adhesive (the adhesive is a mixture of asphalt and carboxymethyl cellulose in a weight ratio of 1:1, i.e., the weight ratio of the asphalt:the carboxymethyl cellulose is 1:1, the amount of the adhesive is 10% of the weight of the second powder), and the second powder and the adhesive in the stirring molding device are stirred and mixed, and molded into spherical particles with a particle size of 6 mm. The spherical particles are put in a heating furnace, carbon dioxide (CO₂) gas is introduced into the heating furnace at 750° C. and 1 MPa, and then the secondary heat treatment is performed on the spherical particles in the heating furnace for 30 minutes to obtain a heat-treated material. The 1% sodium hydroxide aqueous solution is directly sprayed on the heat-treated material to cool it to 70° C. to obtain a cooled material, and then the cooled material is uniformly stirred and mixed with a cotton straw fiber and animal manure in the weight ratio of 10:1:1 (i.e., the weight ratio of the cooled material:the cotton straw fiber:the animal manure is 10:1:1) at 70° C. for 120 minutes to obtain a mixed material, and the mixed material is cooled to room temperature to obtain the coal gangue-based ecological restoration material, which can be used as the ecological restoration material for water and soil loss areas with desertification and rocky desertification and lands occupied by construction.

The coal gangue-based ecological restoration material obtained in this embodiment is directly laid on a surface of a water and soil loss area with desertification and rocky desertification or a surface of a land occupied by construction, with a laying thickness of 50 mm, and local plant grass seeds are directly sprayed on it. The effect of ecological restoration is shown in Table 1.

### Embodiment 2

Coal gangue with a weight content of silicon oxide higher than 60% and a weight content of carbon higher than 20% as a raw material is crushed by a crusher to obtain first powder less than 80 meshes. The first powder is placed in a heating furnace for heat treatment at 500° C. without air for 60 minutes to obtain heat-treated powder. The heat-treated powder is cooled to below 50° C. by indirect cooling to obtain cooled powder. The cooled powder is crushed and sieved to less than 250 meshes to obtain second powder less than 250 meshes. The second powder is put into a stirring molding device with an adhesive (the adhesive is a mixture of asphalt and carboxymethyl cellulose in a weight ratio of 1:5, i.e., the weight ratio of the asphalt:the carboxymethyl cellulose is 1:5, the amount of the adhesive is 8% of the weight of the second powder), and the second powder and the adhesive in the stirring molding device are stirred and mixed, and molded into spherical particles with a particle size of 10 mm. The spherical particles are put in a heating furnace, CO₂ gas is introduced into the heating furnace at 750° C. and 0.5 MPa, and then the secondary heat treatment is performed on the spherical particles in the heating furnace for 60 minutes to obtain a heat-treated material. The 1% potassium hydroxide aqueous solution is directly sprayed on the heat-treated material to cool it to 80° C. to obtain a cooled material, and then the cooled material is uniformly stirred and mixed with a rice straw fiber and animal manure in the weight ratio of 10:5:1 (i.e., the weight ratio of the cooled material:the rice straw fiber:the animal manure is 10:5:1) at 80° C. for 30 minutes to obtain a mixed material, and the mixed material is cooled to room temperature to obtain the coal gangue-based ecological restoration material, which can be used as the ecological restoration material for water and soil loss areas with desertification and rocky desertification and lands occupied by construction.

The coal gangue-based ecological restoration material obtained in this embodiment is directly laid on a surface of a water and soil loss area with desertification and rocky desertification or a surface of a land occupied by construction, with a laying thickness of 100 mm, and local plant grass seeds are directly sprayed on it. The effect of ecological restoration is shown in Table 1.

### Embodiment 3

Coal gangue with a weight content of silicon oxide higher than 60% and a weight content of carbon higher than 20% as a raw material is crushed by a crusher to obtain first powder less than 80 meshes. The first powder is placed in a heating furnace for heat treatment at 400° C. in nitrogen atmosphere for 50 minutes to obtain heat-treated powder. The heat-treated powder is cooled to below 50° C. by indirect cooling to obtain cooled powder. The cooled powder is crushed and sieved to less than 250 meshes to obtain second powder less than 250 meshes. The second powder is put into a stirring molding device with an adhesive (the adhesive is a mixture of asphalt and carboxymethyl cellulose in a weight ratio of 1:3, i.e., the weight ratio of the asphalt:the carboxymethyl cellulose is 1:3, the amount of the adhesive is 9% of the weight of the second powder), and the second powder and the adhesive in the stirring molding device are stirred and mixed, and molded into spherical particles with a particle size of 8 mm. The spherical particles are put in a heating furnace, CO₂ gas is introduced into the heating furnace at 750° C. and 0.8 MPa, and then the secondary heat treatment is performed on the spherical particles in the heating furnace for 40 minutes to obtain a heat-treated material. The 10% sodium carbonate aqueous solution is directly sprayed on the heat-treated material to cool it to 75° C. to obtain a cooled material, and then the cooled material is uniformly stirred and mixed with a corn straw fiber and animal manure in the weight ratio of 10:6:1 (i.e., the weight ratio of the cooled material:the corn straw fiber:the animal manure is 10:6:1) at 75° C. for 100 minutes to obtain a mixed material, and the mixed material is cooled to room temperature to obtain the coal gangue-based ecological restoration material, which can be used as the ecological restoration material for water and soil loss areas with desertification and rocky desertification and lands occupied by construction.

The coal gangue-based ecological restoration material obtained in this embodiment is directly laid on a surface of a water and soil loss area with desertification and rocky desertification or a surface of a land occupied by construction, with a laying thickness of 80 mm, and local plant grass seeds are directly sprayed on it. The effect of ecological restoration is shown in Table 1.

### Embodiment 4

Coal gangue with a weight content of silicon oxide higher than 60% and a weight content of carbon higher than 20% as a raw material is crushed by a crusher to obtain first powder less than 80 meshes. The first powder is placed in a heating furnace for heat treatment at 450° ° C. in nitrogen atmosphere for 50 minutes to obtain heat-treated powder. The heat-treated powder is cooled to below 50° C. by indirect cooling to obtain cooled powder. The cooled powder is crushed and sieved to less than 250 meshes to obtain second powder less than 250 meshes. The second powder is put into a stirring molding device with an adhesive (the adhesive is a mixture of asphalt and carboxymethyl cellulose in a weight ratio of 1:4, i.e., the weight ratio of the asphalt:the carboxymethyl cellulose is 1:4, the amount of the adhesive is 8.5% of the weight of the second powder), and the second powder and the adhesive in the stirring molding device are stirred and mixed, and molded into spherical particles with a particle size of 8 mm. The spherical particles are put in a heating furnace, CO₂ gas is introduced into the heating furnace at 750° C. and 1 MPa, and then the secondary heat treatment is performed on the spherical particles in the heating furnace for 50 minutes to obtain a heat-treated material. The 15% sodium carbonate aqueous solution is directly sprayed on the heat-treated material to cool it to 78° ° C. to obtain a cooled material, and then the cooled material is uniformly stirred and mixed with a cotton straw fiber and urea in the weight ratio of 10:6:1 (i.e., the weight ratio of the cooled material:the cotton straw fiber:the urea is 10:6:1) at 78° C. for 100 minutes to obtain a mixed material, and the mixed material is cooled to room temperature to obtain the coal gangue-based ecological restoration material, which can be used as the ecological restoration material for water and soil loss areas with desertification and rocky desertification and lands occupied by construction.

The coal gangue-based ecological restoration material obtained in this embodiment is directly laid on a surface of a water and soil loss area with desertification and rocky desertification or a surface of a land occupied by construction, with a laying thickness of 60 mm, and local plant grass seeds are directly sprayed on it. The effect of ecological restoration is shown in Table 1.

### Embodiment 5

Coal gangue with a weight content of silicon oxide higher than 60% and a weight content of carbon higher than 20% as a raw material is crushed by a crusher to obtain first powder less than 80 meshes. The first powder is placed in a heating furnace for heat treatment at 480° C. in nitrogen atmosphere for 30 minutes to obtain heat-treated powder. The heat-treated powder is cooled to below 50° C. by indirect cooling to obtain cooled powder. The cooled powder is crushed and sieved to less than 250 meshes to obtain second powder less than 250 meshes. The second powder is put into a stirring molding device with an adhesive (the adhesive is a mixture of asphalt and carboxymethyl cellulose in a weight ratio of 1:2, i.e., the weight ratio of the asphalt:the carboxymethyl cellulose is 1:2, the amount of the adhesive is 8% of the weight of the second powder), and the second powder and the adhesive in the stirring molding device are stirred and mixed, and molded into spherical particles with a particle size of 9 mm. The spherical particles are put in a heating furnace, CO₂ gas is introduced into the heating furnace at 750° ° C. and 0.9 MPa, and then the secondary heat treatment is performed on the spherical particles in the heating furnace for 40 minutes to obtain a heat-treated material. The 1% sodium hydroxide aqueous solution is directly sprayed on the heat-treated material to cool it to 73° ° C. to obtain a cooled material, and then the cooled material is uniformly stirred and mixed with a cotton straw fiber and urea in the weight ratio of 10:6:1 (i.e., the weight ratio of the cooled material:the cotton straw fiber:the urea is 10:6:1) at 73° C. for 100 minutes to obtain a mixed material, and the mixed material is cooled to room temperature to obtain the coal gangue-based ecological restoration material, which can be used as the ecological restoration material for water and soil loss areas with desertification and rocky desertification and lands occupied by construction.

The coal gangue-based ecological restoration material obtained in this embodiment is directly laid on a surface of a water and soil loss area with desertification and rocky desertification or a surface of a land occupied by construction, with a laying thickness of 90 mm, and local plant grass seeds are directly sprayed on it. The effect of ecological restoration is shown in Table 1.

Table 1 shows the ecological restoration effects of the embodiments.

TABLE 1

| | | Plant growth |
|---|---|---|
| Embodi- | | status after |
| ment | Ecological restoration process | three months |
| Embodi- | The ecological restoration material is laid | The vegetation |
| ment | on the surface of the land to be | coverage rate |
| 1 | ecologically restored, with a thickness of | is 81%. |
| | 50 mm, and sprayed with local native | |
| | plant grass seeds. | |
| Embodi- | The ecological restoration material is laid | The vegetation |
| ment | on the surface of the land to be | coverage rate |
| 2 | ecologically restored, with a thickness of | is 93%. |
| | 100 mm, and sprayed with local native | |
| | plant grass seeds. | |
| Embodi- | The ecological restoration material is laid | The vegetation |
| ment | on the surface of the land to be | coverage rate |
| 3 | ecologically restored, with a thickness of | is 87%. |
| | 80 mm, and sprayed with local native | |
| | plant grass seeds. | |
| Embodi- | The ecological restoration material is laid | The vegetation |
| ment | on the surface of the land to be | coverage rate |
| 4 | ecologically restored, with a thickness of | is 83%. |
| | 60 mm, and sprayed with local native | |
| | plant grass seeds. | |
| Embodi- | The ecological restoration material is laid | The vegetation |
| ment | on the surface of the land to be | coverage rate |
| 5 | ecologically restored, with a thickness of | is 86%. |
| | 90 mm, and sprayed with local native | |
| | plant grass seeds. | |

What is claimed is:

1. A coal gangue-based ecological restoration material, made from the following raw materials in parts by weight:
10 parts by weight of coal gangue;
0.5-1 parts by weight of an adhesive;
1-10 parts by weight of a plant fiber; and
1 part by weight of a fertilizer.

2. The coal gangue-based ecological restoration material as claimed in claim 1, wherein the coal gangue is coal gangue with silicon oxide content higher than 60% and carbon content higher than 20%.

3. The coal gangue-based ecological restoration material as claimed in claim 1, wherein the adhesive is a mixture of asphalt and carboxymethyl cellulose in a weight ratio of 1:1 to 1:5.

4. The coal gangue-based ecological restoration material as claimed in claim 1, wherein the plant fiber is one selected from the group consisting of a cotton straw fiber, a rice straw fiber and a corn straw fiber.

5. The coal gangue-based ecological restoration material as claimed in claim 1, wherein the fertilizer is one selected from the group consisting of an organic fertilizer, a chemical fertilizer and a mixture of an organic fertilizer and a chemical fertilizer; and the organic fertilizer comprises animal manure and the chemical fertilizer comprises urea.

6. A preparation method of the coal gangue-based ecological restoration material as claimed in claim 1, wherein the coal gangue-based ecological restoration material is prepared by taking the coal gangue as a main material, and the preparation method comprises the following steps:
(1) primary crushing: crushing the coal gangue by a crusher to obtain first powder less than 80 meshes;
(2) primary heat treatment: placing the first powder in a heating furnace to perform heat treatment at 300-500° C. without air or in inert atmosphere for 30-60 minutes to obtain heat-treated powder;
(3) primary cooling: cooling the heat-treated powder to below 50° C. by indirect cooling without direct contact with cooling water to obtain cooled powder;
(4) secondary crushing: crushing and sieving the first cooled powder to below 250 meshes to obtain second powder less than 250 meshes;
(5) mixing and molding: putting the second powder and the adhesive into a stirring molding device to stir and mix, and mold into spherical particles with a particle size of 6-10 mm;
(6) secondary heat treatment: placing the spherical particles in a heating furnace, introducing carbon dioxide gas into the heating furnace at 750° C. and 0.5-1 MPa, and performing heat treatment on the spherical particles in the heating furnace for 30-60 minutes to obtain a heat-treated material;
(7) secondary cooling: directly spraying alkaline aqueous solution on the heat-treated material to cool to 70-80° C. to obtain a cooled material;
(8) mixing: evenly stirring and mixing the cooled material, the plant fiber and the fertilizer at 70-80° ° C. for 30-120 minutes according to a weight ratio of 10:(1-10):1, thereby to obtain a mixed material; and
(9) cooling and molding: cooling the mixed material to obtain the coal gangue-based ecological restoration material.

7. The preparation method as claimed in claim 6, wherein the alkaline aqueous solution comprises: 1% sodium hydroxide aqueous solution, 1% potassium hydroxide aqueous solution or 10%-15% sodium carbonate aqueous solution; and a weight ratio of the alkaline aqueous solution to the second heat-treated powder is 1 to 3:10.

8. An application method of the coal gangue-based ecological restoration material as claimed in claim 1, comprising: taking the coal gangue-based ecological restoration material as an ecological restoration material for a water and soil loss area with desertification and rocky desertification, specifically comprising:
directly laying the coal gangue-based ecological restoration material on a surface of the water and soil loss area with desertification and rocky desertification, with a laying thickness of 50-100 mm, and then directly spraying plant grass seeds on the coal gangue-based ecological restoration material;
wherein after three months of construction, a vegetation coverage rate is over 80%.

9. An application method of the coal gangue-based ecological restoration material as claimed in claim 1 in an area requiring ecological restoration of a land occupied by construction, comprising: directly laying the coal gangue-based ecological restoration material on a ground surface of the land occupied by construction, with a laying thickness of 50-100 mm, and then directly spraying plant grass seeds on the coal gangue-based ecological restoration material; and
wherein after three months of construction, a vegetation coverage rate is over 80%.
